(19) United States
(12) Patent Application Publication
(10) Pub. No.: US 2007/0161118 A1
(43) Pub. Date: Jul. 12, 2007

(54) Mixing of fluids

(76) Inventors: Gerd Luedke, Holzgerlingen (DE); Andreas Ruefer, Karlsruhe (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/580,478

(22) PCT Filed: Jan. 29, 2004
(86) PCT No.: PCT/EP04/50051

§ 371 Date: Jan. 4, 2007

(51) Int. Cl. G01N 1/10

(52) U.S. Cl. 436/180

(57) ABSTRACT

A method for mixing at least two fluids comprising: (a) introducing the at least two fluids into a common first conduit which includes a junction with a second conduit and transporting the fluids to the junction, (b) subjecting the fluids in the first conduit at the junction to a force in order to alternately change the direction of flow of the fluids.

### BACKGROUND ART

Microfluidic devices, also referred to as lab-on-chip or simply as chips, have gained wide acceptance as alternatives to conventional analytical tools in research and development laboratories in both academia and industry. For example, in the field of biology microfluidic devices can be used to carry out cellular assays and in the field of analytical chemistry microfluidic devices may be used to carry out separation techniques.

Some of the advantages of microfluidic devices and systems are the smaller amount of reagent required and the greater speed of the analysis. Microfluidic chambers and channels also measure volumes more consistently than human hands and can thus help reduce error rates.

One of the problems associated with microfluidic devices, in particular in the fields of biology and analytical chemistry, is the problem of mixing nano liter volumes of liquid. This problem is described in more detail in the article “Honey, I shrunk the lab”, in Nature Vol. 118, August 2002, page 447 to 457 where two approaches to accelerating the mixing process are described. The first approach Involves the stretching and folding of fluid layers as they move down the channel by using a herring bone pattern of ridges on the channel floor. The second approach involves the application of an alternating current along the channel to cause the fluid to oscillate in the channel.

Further approaches to alleviating the problem of mixing in microfluidic devices are described In “Chaotic Mixing in Electrokinetically and Pressure Driven Micro Flows” by Yi-Kuen Lee at al. in 2001 IEEE 483-486. The focus here is to induce folding and stretching of material lines which lead to chaotic-like mixing.

### DISCLOSURE OF THE INVENTION

It is an object of the invention to improve the mixing of at least two fluids. The invention is especially advantageous for the mixing of at least two fluids in a microfluidic device. For example, the rate of mixing of the fluids can be improved and/or the Improved mixing technique can be relatively easily applied to new or existing microfluidic devices and/or systems. The object is solved by the independent claims. Preferred embodiments are described in the dependent claims.

According to the present invention, at least two fluids are introduced into a common first conduit which includes a junction with a second conduit. The fluids are transported to the junction and subjected to an alternating force while remaining essentially in the first conduit. The alternating force causes the direction of flow of the fluids to alternately change in direction.

Embodiments of the invention can be used to mix fluids containing at least one component from any of the following groups: peptides, polypeptides, nucleic acids, carbohydrates, dyes, fatty acids.

A preferred embodiment encompasses an apparatus for mixing at least two fluids where a first conduit is adapted for receiving the at least two fluids. The first conduit forms a junction with a second conduit. A first energy source is applied to transport the fluids in the first conduit and a second energy source is applied to subject the fluids in the first conduit at the junction to an alternating force which alternately changes the direction of fluid flow.

Further preferred embodiments include a microfluidic device for mixing at least two fluids. The microfluidic device comprises a substrate having at least one open microchannel formed in a surface of the substrate, a coverplate arranged over the substrate surface covering the open side of the microchannel, a first conduit and a second conduit both defined by the coverplate in combination with the open microchannel, a first energy source for transporting the fluids in the first conduit and a second energy source for subjecting the fluids in the first conduit at the junction to an alternating force which correspondingly changes the direction of fluid flow. The second conduit forms a junction with the first conduit. The first and second conduit are intended for mixing the at least two fluids and the at least two fluids are introduced into the first conduit. The second energy source is preferably comprised of at least two electrodes located in the second conduit. At least one electrode is then arranged on each side of the junction in the second conduit.

### BRIEF DESCRIPTION OF DRAWINGS

Other objects and many of the attendant advantages of embodiments of the present invention will be readily appreciated and become better understood by reference to the following more detailed description of preferred embodiments in connection with the accompanied drawing(s). Features that are substantially or functionally equal or similar will be referred to with the same reference sign(s).

FIG. 1 schematically illustrates a first and second conduit of a microfluidic device and fluid flow through the first conduit; and

FIGS. 2a and 2b schematically illustrate a top view of a LabChip for a 2100 bioanalyzer in which the method according to the invention is employed.

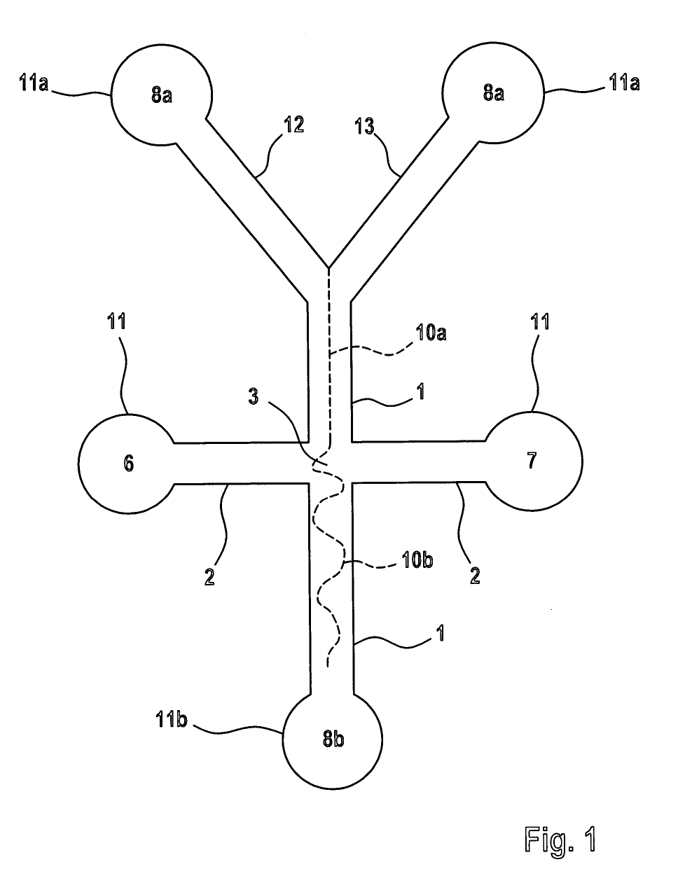

FIG. 1 shows an example of a basic layout of a first conduit relative to a second conduit according to the invention. By way of example, two fluids are introduced into the system by pipetting each sample into an electrode well 11a. The pipetting of the sample can be achieved by hand. In this example, a first energy source is represented as an electric field produced by a potential difference between the electrodes 8a, 8b and a second energy source is represented as an electric field produced by a potential difference between the electrodes 6,7. Other sources of energy such as the application of a pressure gradient as the first and/or second energy sources are also envisaged.

The conduits of the microfluidic device are preferably formed by open channels in the lab-on-a-chip which are covered and/or sealed by a cover plate (which is not illustrated in FIG. 1). The conduits are therefore essentially closed vessels for the transport of fluid. Electrodes 6,7, 8a, 8b are commonly inserted into electrode wells 11, 11a, 11b located In the channels of the chip.

Each of the two fluids are transported from the respective electrode well 11a into the first conduit 1 preferably electrokinetically by application of an electrical potential between the transport electrodes 8a, 8b. At least one transport electrode 8a is located in each of the electrode wells 11a and have the same polarity. At least one electrode 8b of opposite polarity is located in an electrode well 11b. An electric field producing a current preferably between 2 μA and 5 μA in the case of a standard 2100 Bioanalyzer from Agilent Technologies is produced between the transport electrodes 8a and 8b. The transport current is not limited to these values, but rather depends on the geometry of the conduits and the physical characteristics of the fluids such as viscosity and temperature. The transport of the two fluids in not limited to electrokinetic transport, but may also be transported by other means known in the art.

In this example of the invention, the two fluids flow separately in sample conduits 12,13 (which can also be regarded as parts of the first conduit 1) and then join paths in the first conduit 1. It is also possible to introduce the fluids directly from the electrode wells 11a into the first conduit 1 without the need for sample conduits 12,13.

Due to the micrometer, if not nanometer dimensions of the conduits, the fluid flow of the two fluids in the sample conduits 12,13 and the first conduit 1 is substantially laminar. Mixing of liquids occurs by the diffusion of liquids into each other across the interface between the liquids. On a macro level, this process can be sped up by stirring because the turbulence created increases the interfacial surface area between the liquids. However turbulent flow faces opposition in the shape of the viscosity of the two liquids, which tends to keep fluid motion stable. Accordingly, in a sufficiently small sample (i.e. on a micro level), the sample will not generate sufficient momentum to overcome the obstacle of viscosity. Consequently two fluids at the micro level tend to travel side by side through a narrow channel (i.e. in laminar flow) and only become fully mixed after many centimeters. Laminar flow in the first conduit 1 is schematically illustrated by the dashed line 10a running substantially parallel to the net fluid flow. The dashed line 10a, 10b schematically represents the interfacial surface area between the two fluids.

The first conduit 1 forms a junction 3 with a second conduit 2. The junction according to the invention is also often referred to in the art as a mixing tee or mixing cross. The second conduit is located preferably substantially perpendicular to the first conduit 1. However the invention also encompasses a first conduit 1 forming a junction 3 with a second conduit 2 at any other angles.

The second conduit 2 preferably contains a solution with charged or chargeable particles or a charged or chargeable fluid. This fluid in the second conduit 2 acts essentially as a conductive medium for the electric field between the mixing electrodes 6,7. At least one electrode 6,7 is located on each side of the junction 3 in the second conduit 2 and an electrical potential (i.e. voltage difference) is applied between these mixing electrodes 6,7 on either side of the junction 3 for the purpose of producing the electric field for “a mixing”. In this example one electrode 6,7 is located at each of the two ends of the second conduit 2. The electrodes 6,7 can however, also be located at any other location in the second conduit as long as at least one electrode is located on each side of the junction 3. The electrodes 6,7 are each inserted into an electrode well 11.

According to this example of the invention the electrodes 6,7 apply an alternating electric field across the junction 3, in particular a pulsating alternating electric field. This means that an electrical force is applied in one direction to the fluids flowing in the first conduit 1 at a substantially right angle to the net fluid flow in the first conduit 1 (due the preferred relative arrangement of the first and second conduits 1,2). When the electric field is alternated to the opposite polarity after a given time interval, a force in the opposite direction is applied to the fluids in the first conduit 1, also at a substantially right angle to the net fluid flow in the first conduit 1. The electric field between the electrodes 6 and 7 is preferably alternated at a frequency which allows at least a substantial amount of the fluid in the first conduit to move by means of the electric field from one conduit wall to the opposite conduit wall. This frequency f corresponds to the preferred time interval (1/2 f).

The preferred time interval between alternating polarities of the electric field depends on a number of parameters such as the dimensions of the first conduit 1, the temperature of the fluids, the size of the charged/polarizable particles in the fluid or solution and the viscosity of the fluid. The electric field between the mixing electrodes 6,7 largely depends on the geometry of the channels, the densities of the charged particles/molecules, the fluid viscosity, and temperature. For the 2100 Bioanalyzer (Agilent Technologies, Inc.) the electric field for mixing preferably produces a current of at least ±2 μA. The electric field can also be controlled by adjusting the voltage applied between the respective electrodes 8a, 8b, 6, 7.

As a result of the electric force alternating in direction at substantially right angles to the net flow through the first conduit 1, the interfacial surface area between the fluid in the first conduit 1 is increased (i.e. “stretched”). The increased interfacial surface area increases the rate of mixing between the fluids. This means that a mixed fluid is obtained after passage through a shorter conduit length than otherwise. The “stretched” interfacial surface area is represented in FIG. 1 by the curved dashed line 10b.

The mixed fluid can be collected from the electrode well 11b in the first conduit 1.

An advantage of the invention is that it may be applied to existing lab-on-a-chips/microfluidic devices and may be used in existing microfluidic systems without costly alterations. Alterations to the layout of the existing microfluidic device can be largely dispensed with.

The term fluid used here is intended to encompass all materials and substances in the liquid or fluid phase or which can be subject to fluid flow; it particularly includes substances (such as charged particles and ions) dissolved or suspended in any solution and gels. The term conduit used here also includes a capillary or any dosed or substantially closed vessel for the transport of fluids between at least two locations. A conduit may also include any number of intersections, junctions or branches.

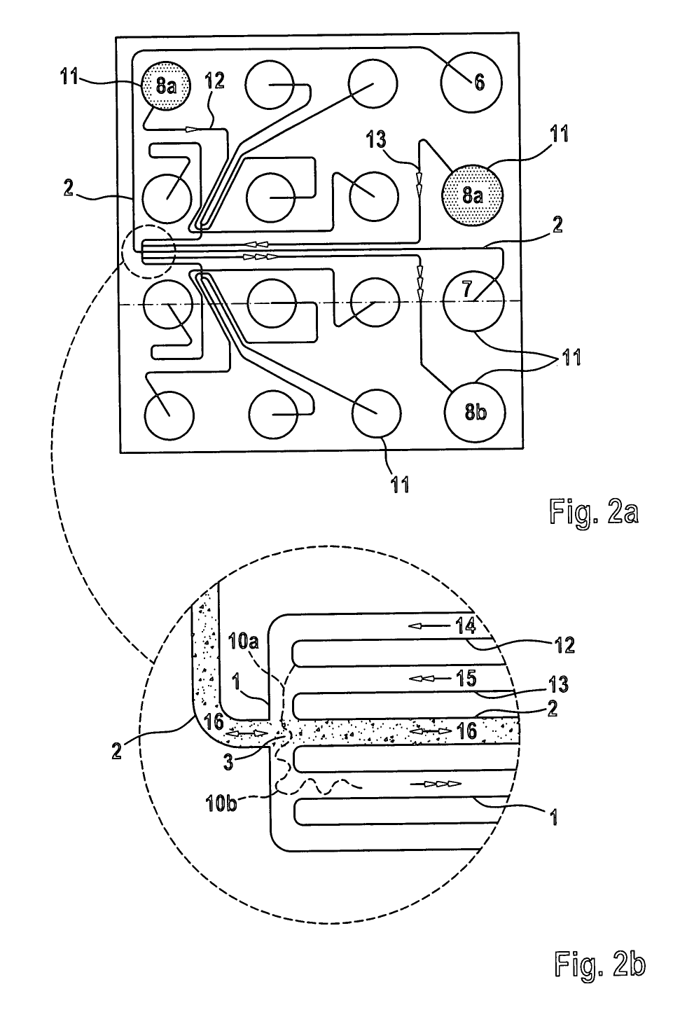

FIG. 2a shows by way of example, the application of a preferred embodiment of the invention to an existing LabChip for the 2100 Bioanalyzer from Agilent Technologies. FIG. 2b shows an enlarged sub-section of FIG. 2a in greater detail.

In this example a protein solution 15 denatured by sodium-dodecylsulfate (“SDS”) is diluted by a phosphate buffer saline solution (PBS solution) 14. The protein solution 15 is preferably transported electrokinetically between the electrodes 8a and 8b. The PBS solution 14 is also preferably transported electrokinetically between the electrodes 8a and 8b. The electric field commonly applied between the electrodes 8a, 8b generates a current (i.e. a transport current) of about 2 μA.

The protein solution 15 and the PBS solution 14 can be introduced into a first conduit 1 via the electrode wells 11 for electrodes 8a. As already described in relation to FIG. 1, the two fluids 14, 15 are subject to an alternating electric field at a junction 3 where a second conduit 2 intersects the first conduit 1. The conduits intersect preferable at a substantially right angle. In this example the second conduit 2 contains a buffer solution which preferable does not react with the protein solution 15 or the PBS solution 14. The mixing electrodes 6, 7 are located in wells 11, for example at each end of the second conduit 2. These rows are commonly referred to as the “buffer” and “dump” wells. The electric field between these electrodes is in this example alternated at intervals of about 0.2 s and the electric field applied generates a current of about ±2 μA.

During application of the mixing electric field, the transport current for the protein solution 15 and the PBS solution 14 may be increased from 2 μA to 5 μA solely so that the fluids are better visible by fluorescence microscopy. The laminar flow of the protein solution 15 and PBS solution 14, as indicated by the dashed-line 10a is disturbed at the junction 3 by the electric field between the mixing electrodes 6,7. After the junction 3, a wave-like pattern is formed at the interface between the protein solution 15 and the PBS solution 14. This wave-like Interface translates into a greater Interfacial surface area. Consequently, diffusion of the two solutions into one another is facilitated and accelerated.

The application of the method according to the invention is not limited to the 2100 Bioanalyzer but rather, can be applied to any other microfluidic devices and systems.

The scope of the invention is not limited to the embodiments shown in the figures. The invention is embodied in each novel characteristic and each combination of characteristics, which includes every combination of any features which are stated in the claims, even if this combination of features is not explicitly stated in the claims.

1. A method for mixing at least two fluids comprising:
(a) introducing the at least two fluids into a common first conduit which includes a junction with a second conduit and transporting the fluids to the junction, and
(b) subjecting the fluids in the first conduit at the junction to a force in order to alternately change the direction of flow of the fluids.

2. The method of claim 1, wherein the force is produced by at least one of:
an alternating electrical field,
an alternating mechanical energy source, preferably at least one of positive and negative pressure or vacuum.

3. The method of claim 1 or any one of the above claims, wherein the transport of the fluids towards the junction is achieved by at least one of:
(a) an electric field, and/or
(b) a pressure differential.

4. The method of claim 1 or any one of the above claims, wherein the force is applied across the first conduit at the junction perpendicular or substantially perpendicular to the fluid flow in the first conduit.

5. The method of claim 1 or any one of the above claims, wherein the force is applied at the junction utilizing the second conduit.

6. The method of claim 1 or any one of the above claims, wherein the force applied at the junction is alternated after a certain time interval which allows at least a substantial amount of the fluids in the first conduit to move by means of the force from one conduit wall to the opposite conduit wall.

7. The method of claim 1 or any one of the above claims, wherein the force applied at the junction is constantly alternated after a time interval which is dependent on at least one of the following parameters: channel geometry, fluid viscosity, temperature.

8. The method of claim 1 or any one of the above claims, wherein the force applied at the junction is changed from one direction or polarity to the opposite direction or polarity after each time interval.

9. The method of claim 1 or any one of the above claims, wherein the strength of the force applied at the junction is sufficient to move at least a substantial amount of the fluids in the first conduit from one conduit wall to the opposite conduit wall within a given time interval.

10. The method of claim 2 or any one of the above claims, wherein the alternating electric field applied produces a current of at least ±1 μA.

11. The method of claim 1 or any one of the above claims, wherein the fluids are transported electrokinetically at least within the first conduit.

12. The method of claim 11, wherein during application of the force at the junction, the transport currents for the respective fluids are increased or decreased.

13. The method of claim 1 or any one of the above claims, wherein the strength of the force is increased with Increasing mixing time.

14. The method of claim 2 or any one of the above claims, wherein the alternating electric field or the alternating mechanical energy is applied at the two ends of the second conduit.

15. The method of claim 1 or any one of the above claims, wherein a fluid is carried in the second conduit and contains charged or chargeable molecules or particles.

16. The method of claim 15, wherein a buffer solution is carried in the second conduit.

17. The method of claim 2 or any one of the above claims, wherein the alternating electric field across the junction is produced by arranging at least one electrode at each of the two ends of the second conduit.

18. The method of claim 1 or any one of the above claims, wherein the at least two fluids comprise charged or chargeable components, preferably ions.

19. Use of the method according to claim 1 or any one of the above claims to mix fluids containing at least one component from any of the following groups: peptides, polypeptides, nucleic acids, carbohydrates, dyes, fatty acids.

20. An apparatus for mixing at least two fluids, comprising:
a first conduit adapted for receiving the at least two fluids, wherein the first conduit comprises a junction with a second conduit,
a first source of energy adapted for transporting the fluids to the junction,
a second source of energy adapted for subjecting the fluids in the first conduit at the junction to an alternating force in order to alternately change the direction of flow.

21. Microfluidic device for mixing at least two fluids where the microfluidic device comprises:
a substrate having at least one microchannel formed in a surface of the substrate;
a cover plate arranged over the substrate surface;
a first conduit and a second conduit for mixing the at least two fluids defined by the cover plate covering the microchannel wherein the second conduit forms a junction with the first conduit and the first conduit is intended for passage of the at least two fluids;
a first source of energy adapted for transporting the fluids within the first conduit; and
a second source of energy adapted for subjecting the fluids in the first conduit at the junction to an alternating force in order to alternately change the direction of flow.

22. Microfluidic device according to claim 21, wherein the second energy source is comprised of at least two electrodes located in the second conduit wherein at least one electrode is arranged on each side of the junction.
